(19) United States
(12) Patent Application Publication
(10) Pub. No.: US 2018/0210400 A1
(43) Pub. Date: Jul. 26, 2018

(54) PORTABLE APPARATUS CASE, PORTABLE APPARATUS, AND TIMEPIECE

(71) Applicant: Seiko Instruments Inc., Chiba-shi (JP)

(72) Inventors: Takahiro Kaneko, Chiba-shi (JP); Teruo Kato, Chiba-shi (JP); Hideaki Koshoji, Chiba-shi (JP); Yasunori Hara, Chiba-shi (JP)

(21) Appl. No.: 15/879,063

(22) Filed: Jan. 24, 2018

(30) Foreign Application Priority Data
Jan. 26, 2017 (JP) 2017-012249

(51) Int. Cl. G04B 37/14; A44C 5/16; A44C 5/20

(52) U.S. Cl. CPC G04B 37/1486; A44C 5/2071; A44C 5/16

(57) ABSTRACT

Disclosed are a portable apparatus case, a portable apparatus, and a timepiece allowing easy attachment. A timepiece case includes: a case main body, a first bow having a first passage hole and provided on the case main body, a strap one end portion of which is mounted to the first bow and the other end portion of which is passed through the first passage hole, and a fixation member provided on an extension portion of the strap extending from the first passage hole to the outside and detachably connected to a main portion of the strap extending from the first bow to the first passage hole.

### RELATED APPLICATIONS

This application claims priority under 35 U.S.C. § 119 to Japanese Patent Application Nos. 2017-012249 filed on Jan. 26, 2017, the entire content of which is hereby incorporated by reference.

### BACKGROUND OF THE INVENTION

### Field of the Invention

The present invention relates to a portable apparatus case, a portable apparatus, and a timepiece.

### Description of the Related Art

Conventionally, as a portable apparatus case, there exists, for example, a portable apparatus case as disclosed in JP-A-2009-225834. The above-mentioned portable apparatus case is attached to the arm. The portable apparatus case is equipped with a case main body, and two straps fixed to both sides of the case main body. A buckle is provided at the distal end of one strap. The buckle has a buckle tongue. An annular loosely fitted member is passed onto the one strap. A lock hole is provided at the distal end side of the other strap.

When attaching the portable apparatus case to the arm, the following four operations are conducted:

(1) The case main body is placed on the arm, and the other strap is passed through the buckle of the one strap.

(2) The other strap is pulled to fasten both straps to the arm.

(3) The buckle tongue is passed through the lock hole of the other strap.

(4) The other strap is passed through the loosely fitted member and fixed to the one strap.

In the above portable apparatus case, it is necessary to perform the four operations at the time of attachment, which means the attachment takes time.

### SUMMARY OF THE INVENTION

The present invention has been made in view of the above problem in the related art. It is an object of the present invention to provide a portable apparatus case, a portable apparatus, and a timepiece allowing easy attachment.

According to an aspect of the present invention, there is provided a portable apparatus case equipped with a case main body, a strap mounting portion having a passage hole and provided on the case main body, a strap one end portion of which is mounted to the strap mounting portion and the other end portion of which is passed through the passage hole, and a fixation member provided on an extension portion of the strap extending to the exterior from the passage hole and detachably connected to a main portion of the strap extending from the strap mounting portion to the passage hole.

In the above-described portable apparatus case, when attaching it to the arm or the like, it is only necessary to perform two operations (the strap fastening operation and the strap fixing operation), so that the requisite number of operations for the attachment is reduced as compared with the related art. Thus, it is possible to easily perform the attachment of the portable apparatus case.

In the portable apparatus case, the strap mounting portion may be provided at one end portion of the case main body, and a support portion supporting the main portion may be provided at the other end portion of the case main body.

In this construction, the strap is supported at both end portions of the case main body. Thus, in the portable apparatus case, it is possible to retain the case main body in a stable fashion.

The fixation member may be a lock portion detachably locked to a locked portion formed on the main portion.

In this construction, the extension portion can be fixed to the main portion solely by locking the lock portion to the locked portion, so that the strap fixing operation is facilitated. Thus, in the portable apparatus case, the attachment can be conducted more easily.

The portable apparatus case may be equipped with a slip portion provided on at least one of the strap and a contact portion brought into contact with the strap, and configured to reduce the friction between the strap and the contact portion.

In this construction, the friction at the time of the strap fastening is reduced, and the strap is moved smoothly, so that the strap fastening operation is further facilitated. Thus, the attachment of the portable apparatus case can be conducted with ease.

The slip portion may be a protrusion at least the distal end portion of which is formed in a curved convex configuration.

In this construction, the friction at the time of strap fastening is further reduced, making it possible to easily perform the strap fastening operation.

The slip portion may be a rotation member provided on at least one of the strap and the contact portion, and rotatable around an axis crossing the length direction of the strap.

In this construction, it is possible to reduce the friction at the time of strap fastening, so that it is possible to easily fasten the strap.

According to another aspect of the present invention, there is provided a portable apparatus equipped with the portable apparatus case, and a portable apparatus component accommodated in the portable apparatus case.

In the above portable apparatus, in attaching it to the arm, it is only necessary to perform two operations (the strap fastening operation and the strap fixing operation), so that the number of the requisite operations for the attachment is reduced as compared with the related art. Thus, the attachment can be easily performed.

According to still another aspect of the present invention, there is provided a timepiece equipped with the portable apparatus case, and a movement accommodated in the portable apparatus case.

In the above timepiece, in attaching it to the arm, it is only necessary to perform two operations (the strap fastening operation and the strap fixing operation), so that the number of the requisite operations for the attachment is reduced as compared with the related art. Thus, the attachment can be easily performed.

The portable apparatus case, the portable apparatus, and the timepiece according to the present invention allow easy attachment.

### BRIEF DESCRIPTION OF THE DRAWINGS

FIG. 1 is a perspective view of a timepiece according to a first embodiment of the present invention;

FIG. 2 is a side view of the timepiece according to the first embodiment;

FIG. 3 is a perspective view of a fixation member of the timepiece according to the first embodiment;

FIG. 4 is a diagram illustrating an attachment method for the timepiece according to the first embodiment;

FIG. 5 is a diagram, succeeding to FIG. 4, illustrating the timepiece attachment method;

FIG. 6 is a diagram, succeeding to FIG. 5, illustrating the timepiece attachment method;

FIG. 7 is a perspective view, as seen from the back side, of a timepiece according to a second embodiment of the present invention;

FIG. 8 is a sectional view illustrating how strap portions are superimposed one upon the other at the time of fastening of the strap of the above diagram;

FIG. 9 is a perspective view, as seen from the back side, of a timepiece according to a third embodiment of the present invention;

FIG. 10 is a side view of an upper portion of a timepiece according to another embodiment of the present invention;

FIG. 11 is a sectional view of a timepiece according to another embodiment of the present invention; and

FIG. 12 is a side view of a timepiece according to another embodiment of the present invention.

### DETAILED DESCRIPTION OF THE PREFERRED EMBODIMENTS

Next, embodiments of the present invention will be described with reference to the drawings.

### First Embodiment

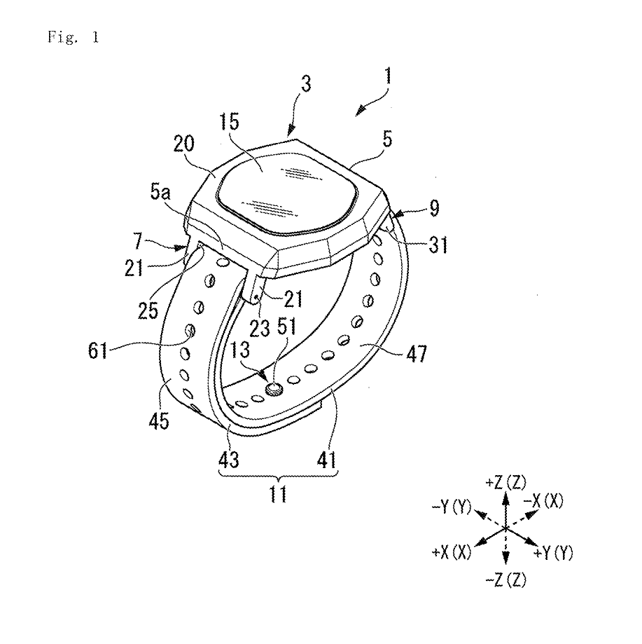

A timepiece (portable apparatus) 1 according to the first embodiment of the present invention will be described with reference to FIGS. 1 through 6. FIG. 1 is a perspective view of the timepiece 1 according to the first embodiment.

As shown in FIG. 1, the timepiece 1 is a watch type electronic timepiece. The timepiece 1 is attached to the arm (wrist). The timepiece 1 is equipped with a timepiece case 3 (portable apparatus case), and a timepiece movement (a portable apparatus component; hereinafter also referred to as a timepiece component).

The timepiece case 3 is equipped with a case main body 5, a first bow 7 (strap mounting portion), a second bow 9 (support portion), a strap 11, and a fixation member 13.

The case main body 5 is formed in a case-like configuration. A “case-like” structure is one capable, for example, of accommodating an object of accommodation.

The case main body 5 is provided with the above-mentioned timepiece component (movement). More specifically, a display portion 15 is provided on the surface (upper surface 20) of the case main body 5. The display portion 15 consists of a flat-plate-like liquid crystal display panel or the like, and displays information such as time. Accommodated in the case main body 5 are the movement, etc. The movement is equipped with a drive unit, a battery, etc., and controls the information display at the display portion 15.

In the following description, the XYZ-coordinate system will be used as needed.

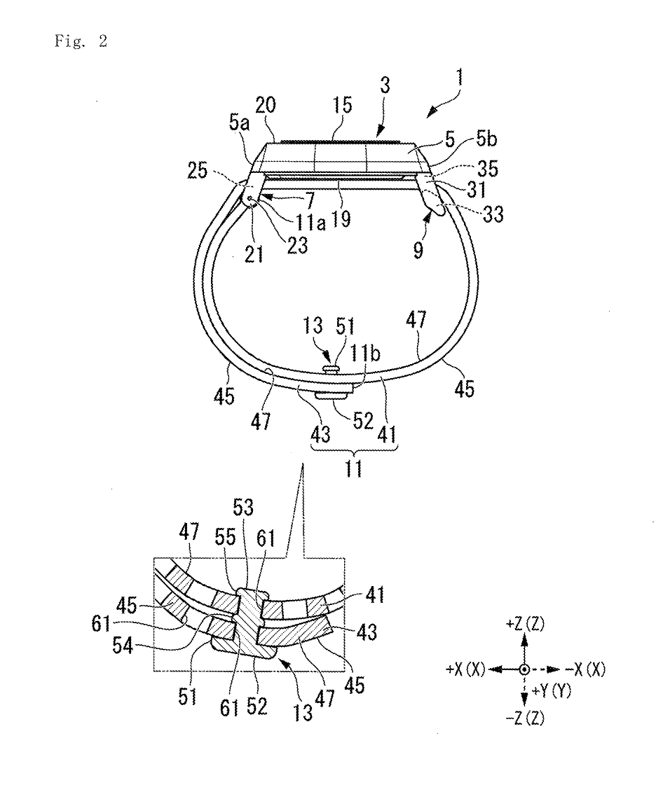

One surface of the flat-plate-like case main body 5 is a lower surface 19 (See FIG. 2) on which the first bow 7 and the second bow 9 are provided. The other surface of the case main body 5 is the upper surface 20 on which the display portion 15 is provided.

The X-direction is along the one surface (lower surface 19) of the case main body 5, and is a direction passing one end portion 5a and the other end portion 5b of the case main body 5. Of the X-direction, the direction from the other end portion 5b toward the one end portion 5a will be referred to as the +X-direction, and the opposite direction will be referred to as the −X-direction. The Y-direction is a direction orthogonal to the X-direction in a plane along the one surface (lower surface 19) of the case main body 5. Of the Y-direction, one direction will be referred to as the +Y-direction, and the opposite direction will be referred to as the −Y-direction. The Z-direction is a direction orthogonal to the X-direction and the Y-direction. It is the thickness direction of the case main body portion 5. In some cases, of the Z-direction, the direction from the lower surface 19 toward the upper surface 20 will be referred to as upwards, and the opposite direction will be referred to as downwards.

The plane formed by the X-direction and the Y-direction is referred to as the XY-plane. The plane formed by the Y-direction and the Z-direction will be referred to as the YZ-plane. The plane formed by the X-direction and the Z-direction will be referred to as the XZ-plane.

The first bow 7 is provided at the one end portion 5a of the case main body 5. The first bow 7 is equipped with a pair of first bow legs 21 and a spring bar 23.

The first bow legs 21 are provided at the one end portion 5a of the case main body 5 so as to be spaced away from each other in the Y-direction. The first bow legs 21 are formed integrally, for example, with the case main body 5. The first bow legs 21 are formed so as to extend substantially downwards from the one end portion 5a of the case main body 5. More specifically, the first bow legs 21 extend downwards from the lower surface 19 of the one end portion 5a of the case main body 5 so as to be slightly tilted in the +X-direction.

The spring bar 23 is provided between the first bow legs 21. Both ends of the spring bar 23 are rotatably mounted to the lower portions (distal end portions in the extending direction) of the first bow legs 21.

Between the spring bar 23 and the one end portion 5a of the case main body 5, there is formed a first passage hole 25 (passage hole or passage portion). The first passage hole 25 allows insertion of the strap 11.

FIG. 2 is a side view of the timepiece 1. The second bow 9 is provided at the other end portion 5b of the case main body 5. The second bow 9 is formed integrally, for example, with the case main body 5. The second bow 9 is equipped with second bow legs 31 and a connection portion 33.

The second bow legs 31 are provided at the other end portion 5b of the case main body 5 so as to be spaced away from each other in the Y-direction. The second bow legs 31 are formed so as to extend substantially downwards from the other end portion 5b of the case main body 5. More specifically, the second bow legs 31 extend downwards from the lower surface 19 of the other end portion 5b of the case main body 5 so as to be slightly tilted in the −X-direction.

The connection portion 33 is provided between the second bow legs 31. Both ends of the connection portion 33 reach the lower portions of the second bow legs 31 (the distal end portions in the extending direction). Between the connection portion 33 and the other end portion 5b of the case main body 5, there is formed a second passage hole 35. The second passage hole 35 allows insertion of the strap 11.

The strap 11 is a strap formed, for example, of leather or resin. The strap 11 can undergo elastic bending deformation in the thickness direction. The strap 11 can undergo elastic deformation so as to increase or decrease the inner diameter dimension, for example, of a lock hole 61.

One end portion 11a of the strap 11 is mounted to the first bow 7. The other end portion 11b of the strap 11 is inserted into the first passage hole 25. That is, the length portion of the strap 11 including the other end portion 11b is inserted into the first passage hole 25.

From its one end portion 11a to the other end portion 11b, the strap 11 has a main portion 41 and an extension portion 43 (surplus length portion).

One end portion of the main portion 41 (the one end portion 11a of the strap 11) is rotatably mounted to the spring bar 23. More specifically, the one end portion 11a is formed in a tubular configuration having an insertion hole, and the spring bar 23 is inserted into the insertion hole. The one end portion 11a is rotatable around an axis with respect to the spring bar 23.

The main portion 41 is the portion of the strap 11 extending from the first bow 7 to the first passage hole 25. The main portion 41 is formed in a ring-like configuration extending from the first bow 7 to the first passage hole 25 via the second bow 9. The main portion 41 is inserted into the second passage hole 35 from the outer side (−X-direction side) of the second bow 9 toward the inner side thereof (+X-direction side), and extends in the +X-direction along the lower surface 19 of the case main body 5 to reach the first passage hole 25. The main portion 41 is inserted into the second passage hole 35, so that it is supported by the connection portion 33 of the second bow 9. The main portion 41 may be of a “loop-like” or “annular” configuration.

The extension portion 43 is the portion of the strap 11 extending to the exterior of the main portion 41 from the first passage hole 25 to the other end portion 11b of the strap 11. The extension portion 43 is superimposed, for example, on the surface 45 of the main portion 41.

Formed in the main portion 41 and the extension portion 43 are a plurality of lock holes 61 extending through the strap 11 in the thickness direction. The lock holes 61 are of a circular configuration as seen in the thickness direction of the strap 11. The plurality of lock holes 61 are formed at different positions in, for example, the length direction of the strap 11. The plurality of lock holes 61 are formed at the intermediate portion in the width direction side by side in the length direction of the strap 11. Of the lock holes 61 formed in the strap 11, a plurality of lock holes 61 formed in the main portion 41 are an example of the “locked portion.”

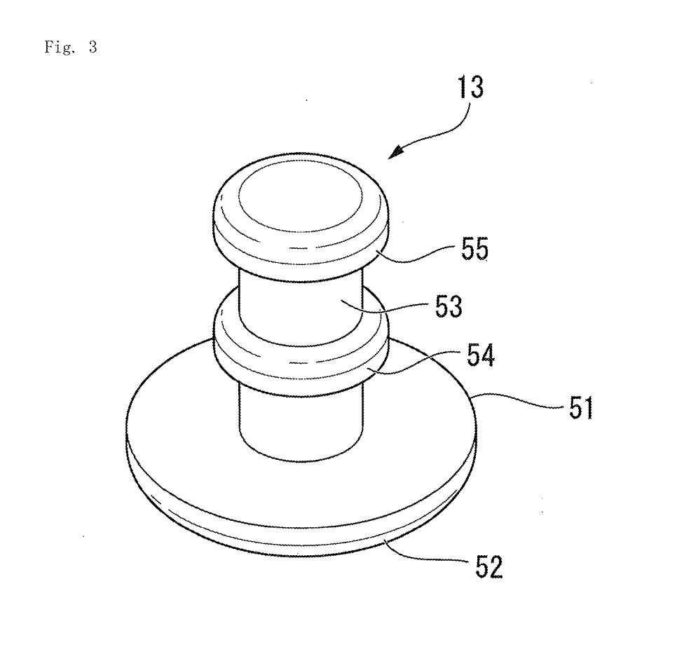

FIG. 3 is a perspective view of the fixation member 13.

As shown in FIG. 3, the fixation member 13 is equipped with a lock portion 51. The lock portion 51 has a head portion 52 and a shaft portion 53. The head portion 52 is formed, for example, in a disc-like configuration.

For example, the shaft portion 53 is formed so as to protrude perpendicularly with respect to the head portion 52 from the center of one surface of the head portion 52. The shaft portion 53 is, for example, formed in a columnar configuration in which the axial direction coincides with the protruding direction, and the outer dimension (outer diameter) of the shaft portion 53 is smaller than the outer dimension (outer diameter) of the head portion 52. The outer dimension (outer diameter) of the shaft portion 53 is smaller, for example, than the inner diameter of the lock holes 61. Thus, the shaft portion 53 can be inserted into the lock hole 61.

Formed on the outer peripheral surface of the shaft portion 53 are a first annular protrusion 54 and a second annular protrusion 55. The first annular protrusion 54 is, for example, an annular protrusion. The first annular protrusion 54 is formed at the intermediate portion in the length direction of the shaft portion 53. The second annular protrusion 55 is formed at the distal end portion in the length direction of the shaft portion 53. The second annular protrusion 55 is, for example, an annular protrusion.

The first annular protrusion 54 and the second annular protrusion 55 protrude outwards in the radial direction of the shaft portion 53 from the outer peripheral surface of the shaft portion 53, and are formed over the entire periphery of the shaft portion 53. The central axes of the first annular protrusion 54 and the second outer protrusion 55 coincide, for example, with the central axis of the shaft portion 53. There are no particular restrictions regarding the sectional configuration (the sectional configuration along the central axis of the shaft portion 53) of the first annular protrusion 54 and the second annular protrusion 55. It may be, for example, of a semi-circular, rectangular, or reverse-V-shaped configuration.

At least a part of the first annular protrusion 54 has, for example, an outer dimension (outer diameter) larger than the inner diameter of the lock holes 61 of the strap 11 (the main portion 41 and the extension portion 43). The outer dimension (outer diameter) of the first annular protrusion 54 is such as will allow passage through the lock hole 61 by pushing open the lock hole 61. Thus, by pushing open the lock hole 61, it can pass through the lock hole 61, and can be detachably locked to the peripheral edge portion of the lock hole 61.

At least a part of the second annular protrusion 55 has, for example, an outer dimension (outer diameter) larger than the inner diameter of the lock holes 61 of the strap 11 (the main portion 41). The outer dimension (outer diameter) of the second annular protrusion 55 is such as will allow passage through the lock hole 61 by pushing open the lock hole 61. Thus, by pushing open the lock hole 61, it can pass through the lock hole 61, and can be detachably locked to the peripheral edge portion of the lock hole 61.

The distance between the head portion 52 and the first annular protrusion 54 is, for example, the same as or somewhat larger than the thickness of the strap 11 (the extension portion 43). The distance between the first annular protrusion 54 and the second annular protrusion 55 is, for example, the same as or somewhat larger than the thickness of the strap 11 (the main portion 41).

The lock portion 51 can be attached to any of the plurality of lock holes 61.

As shown in FIG. 2, the shaft portion 53 of the lock portion 51 is inserted into the lock holes 61 of the main portion 41 and the extension portion 43 from the front surface 45 side of the extension portion 43. The head portion 52 is arranged on the front surface 45 of the extension portion 43.

The shaft portion 53 is inserted into the lock holes 61 of the main portion 41 and the extension portion 43, whereby the extension portion 43 is regulated in the movement in the length direction with respect to the main portion 41.

The shaft portion 53 is inserted into the lock hole 61 of the extension portion 43 at the other end portion 11b of the strap 11, whereby the distal end portion of the extension portion 43 (the portion including the other end portion 11b) is fixed to the main portion 41.

The first annular protrusion 54 is between the main portion 41 and the extension portion 43, and is detachably locked to a front surface 45 side peripheral edge portion of the lock hole 61 of the main portion 41 and a back surface 47 side peripheral edge portion of the lock hole 61 of the extension portion 43. The second annular protrusion 55 is on the back surface 47 side of the main portion 41, and is detachably locked to the back surface 47 side peripheral edge portion of the lock hole 61 of the main portion 41.

As a result, the main portion 41 and the extension portion 43 are set in position with respect to the lock portion 51. Thus, the extension portion 43 is detachably connected and fixed to the main portion 41.

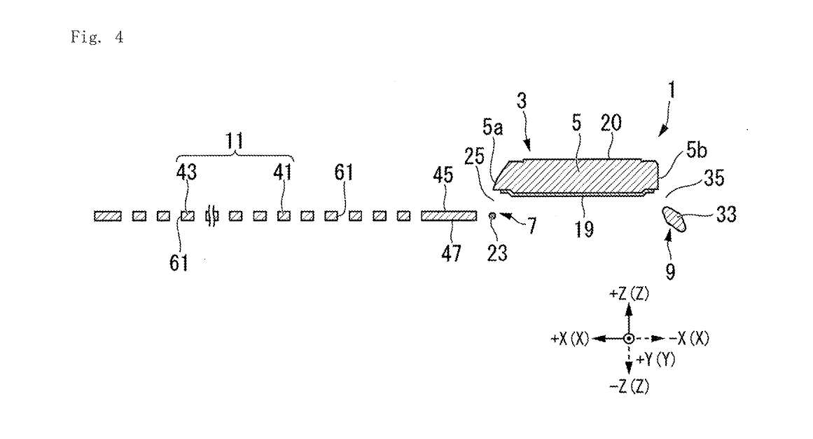

FIGS. 4 through 6 are diagram illustrating a method of attaching the timepiece 1. The method of attaching the timepiece 1 will be described with reference to FIGS. 4 through 6.

[1] Formation of the Main Portion 41

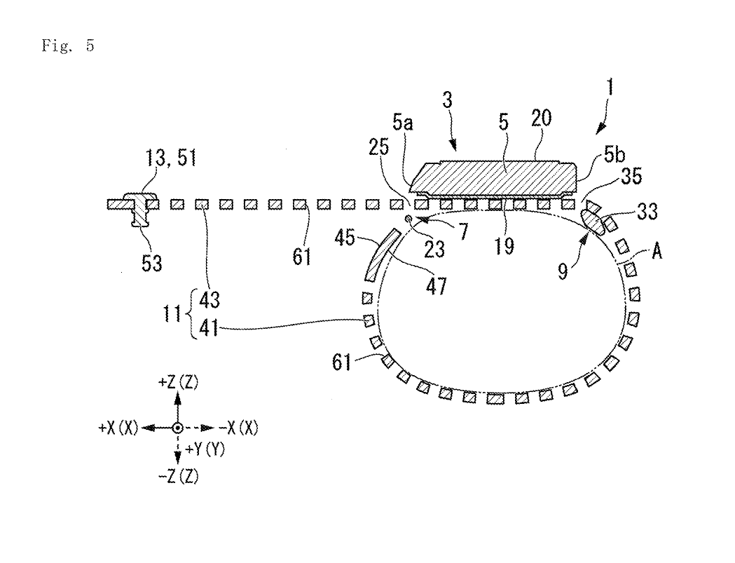

In the state shown in FIG. 4, in which the strap 11 is extended, the distal end portion of the strap 11 is successively passed through the second passage hole 35 and the first passage hole 25 to form the ring-like main portion 41 as shown in FIG. 5. The main portion 41 is in the condition in which an arm A is passed therethrough. The lock portion 51 may be previously attached to the lock hole 61 of the distal end portion of the extension portion 43 (the portion including the other end portion 11b), or it may be attached to the lock hole 61 at the time of a fixing operation (described below).

[2] Strap 11 Fastening Operation

As shown in FIG. 5, in the state in which the arm A is passed through the main portion 41, the extension portion 43 is pulled to fasten the strap 11 (the main portion 41) to the arm A.

[3] Strap 11 Fixing Operation

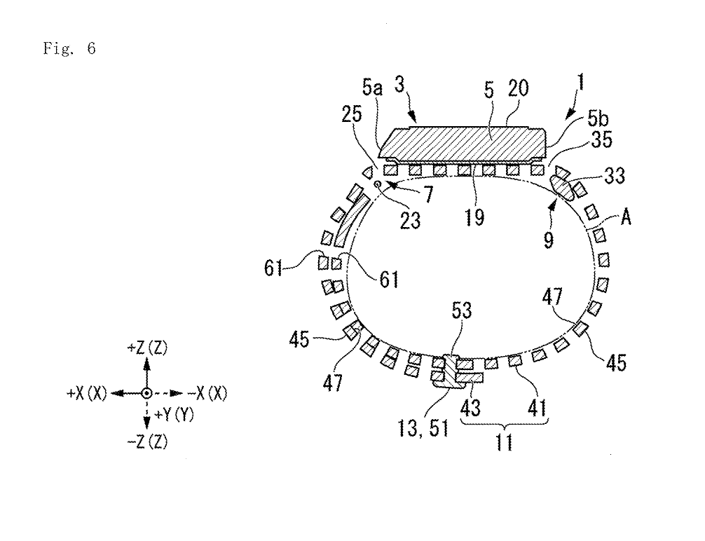

As shown in FIG. 6, the extension portion 43 is superimposed on the main portion 41, and the lock portion 51 is inserted into the lock hole 61 of the extension portion 43 for locking, thereby fixing the extension portion 43 to the main portion 41. As a result, the strap 11 is fixed to the arm A, and the timepiece 1 is attached to the arm A.

The effects of the timepiece case 3 will be described.

(1) When attaching the timepiece case 3 to the arm A, it is only necessary to perform two operations with one hand (the strap 11 fastening operation and the strap 11 fixing operation) in the state in which the arm A has been passed through the main portion 41, so that the number of the requisite operations for attachment is reduced as compared with the related-art timepiece case. Thus, the timepiece case 3 allows easy attachment.

(2) In the timepiece case 3, the second bow 9 supporting the main portion 41 is provided at the other end portion 5b of the case main body 5. As a result, the strap 11 is supported by both end portions (the one end portion 5a and the other end portion 5b) of the case main body 5. Thus, at the time of attachment, the timepiece case 3 can retain the case main body 5 in a stable manner.

(3) In the timepiece case 3, the extension portion 43 can be fixed to the main portion 41 solely by locking the lock portion 51 to the lock hole 61, so that the strap 11 fixing operation is facilitated. Thus, the timepiece case 3 can further facilitate the attachment.

(4) In the timepiece case 3, the lock portion 51 can be detachably locked to any of the plurality of lock holes 61 of the main portion 41, so that it is possible to arbitrarily determine the fixing position of the strap 11. Thus, it is possible, for example, to provide the lock portion 51 at a position where an external force is not easily exerted. Thus, the timepiece case 3 is superior in usability.

(5) In the timepiece 3, the second bow 9 is formed integrally with the case main body 5, so that, as compared with the case where the second bow 9 is formed as a member separate from the case main body 5, the number of components is reduced, thereby suppressing an increase in component cost. Thus, in the timepiece case 3, it is possible to suppress the production cost.

(6) In the timepiece case 3, the strap 11 is used without being folded back, so that it is possible to suppress the load applied to the strap 11 at the time of attachment/detachment. Thus, the timepiece case 3 can prevent damage such as fracture of the surface of the strap 11, which proves the timepiece case to be superior in durability.

(7) In the timepiece case 3, the strap 11 is used without being folded back, so that there is generated no gap due to the folding back of the strap 11. As a result, it is possible to suppress an increase in the dimension in the thickness direction of the strap 11 at the end of the case main body 5. Thus, the timepiece case 3 provides a satisfactory attachment comfort, and is superior in external view (outward appearance).

(8) In the timepiece case 3, the first bow 7 and the second bow 9 are formed integrally with the case main body 5, so that the production of the case main body 5 is easy, and it is possible to suppress the production cost.

(9) The timepiece 1 is equipped with the timepiece case 3, so that, when attaching it to the arm A, it is only necessary to perform two operations with one hand (the strap 11 fastening operation and the strap 11 fixing operation), so that the requisite number of operations for the attachment is reduced as compared with the related art. Thus, the timepiece 1 allows easy attachment.

While in the above embodiment the timepiece case 3 is equipped with the first bow 7 and the second bow 9, the construction of the timepiece case is not restricted thereto. In the timepiece case of the embodiment, it is only necessary that the portion including the other end portion of the strap be inserted into the first passage hole of the first bow and be fixed to the strap. For example, as described below, a construction equipped with no second bow is also possible.

### Second Embodiment

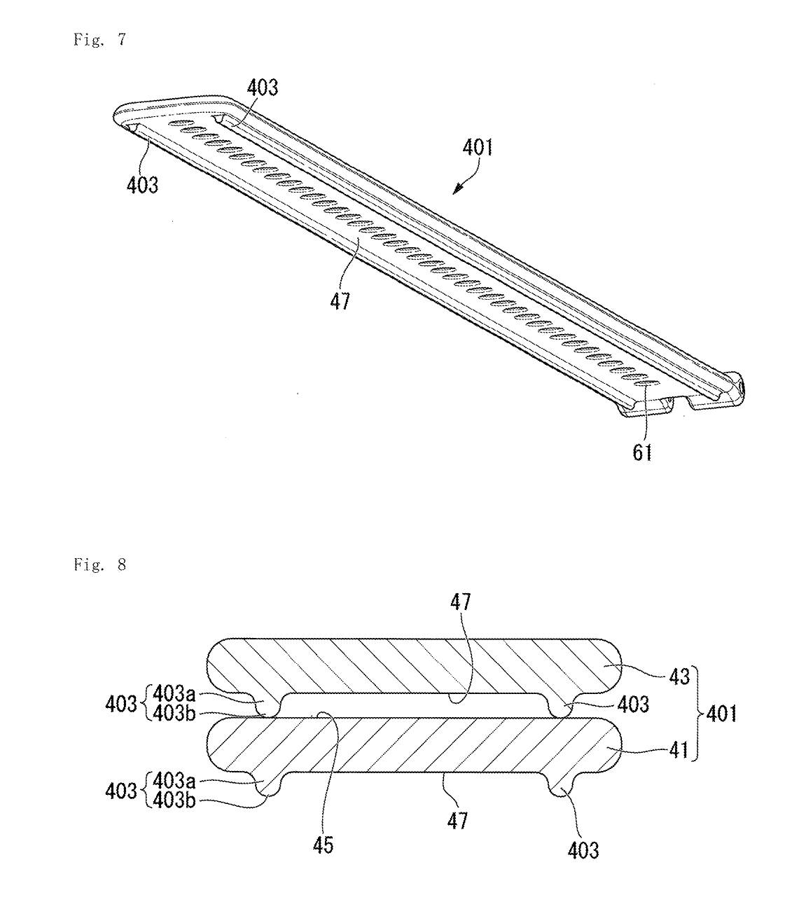

The second embodiment of the present invention will be described with reference to FIGS. 7 and 8. The components that are the same as those of the above-described embodiment are indicated by the same reference numerals, and a description thereof will be left out.

FIG. 7 is a perspective view, as seen from the back side, of a timepiece case strap 401 according to the second embodiment.

As shown in FIG. 7, on the back surface 47 of the strap 401, there are provided a pair of protrusions 403 (slip portions). The pair of protrusions 403 are provided so as to be elongated in the length direction of the strap 401. The pair of protrusions 403 are provided at an interval in the width direction of the strap 401.

FIG. 8 is a sectional view illustrating how the main portion 41 and the extension portion 43 are superimposed one upon the other when the strap 401 is fastened. FIG. 8 is a sectional view taken along a direction orthogonal to the direction in which the protrusions 403 extend.

As shown in FIG. 8, the protrusion 403 is formed so as to protrude from the back surface 47 of the strap 401. The protruding direction of the protrusion 403 is, for example, a direction perpendicular to the back surface 47 (downwards as seen in FIG. 8).

The protrusion 403 has a proximal portion 403a gradually reduced in width toward the distal end, and a distal end portion 403b provided at the distal end side of the proximal portion 403a and of a curved convex configuration. The distal end portion 403b is, for example, of a semi-circular sectional configuration. The protrusion 403 can be formed integrally with the strap 401.

When fastening the strap 401, the extension portion 43 is superimposed on the front surface 45 (contact portion) of the main portion 41. The distal end portions 403b of the protrusions 403 provided on the back surface 47 of the extension portion 43 come into contact with the front surface 45 of the main portion 41. Thus, the contact area of the extension portion 43 with respect to the main portion 41 is reduced. As a result, the protrusions 403 can reduce the friction between themselves and the front surface 45 of the main portion 41.

In addition to the front surface 45 of the main portion 41 shown in FIG. 8, examples of the contact portion coming into contact with the extension portion 43 include the spring bar 23 of the first bow 7 (See FIG. 4) and the connection portion 33 of the second bow 9 (See FIG. 4).

The effects of the timepiece case according to the second embodiment will be described.

(1) In the timepiece case of the second embodiment, the protrusions 403 (slip portions) are formed on the strap 401. As a result, the timepiece case reduces the friction of the strap 401 at the time of the fastening of the strap 401 and moves the strap 401 smoothly, so that the operation of fastening the strap 401 can be conducted easily. Thus, the timepiece case of the second embodiment allows easy attachment.

(2) The protrusions 403 can be formed integrally with the strap 401, so that it is possible to suppress the production cost of the timepiece case.

(3) The distal end portions 403b of the protrusions 403 are formed in a curved convex configuration, so that the friction at the time of the fastening of the strap 401 is further reduced, facilitating the operation of fastening the strap 401.

While in the timepiece case of the second embodiment the protrusions 403 are provided so as to extend in the length direction of the strap 401, the construction of the slip portions is not restricted to the example shown in the drawings. For example, the slip portions may adopt a construction in which a plurality of protrusions are intermittently provided in the length direction of the strap 401.

While in the timepiece case of the second embodiment the protrusions 403 are provided solely on the back surface 47, the protrusions 403 may be provided solely on the front surface 45 of the strap 401, or they may be provided on both the front surface 45 and the back surface 47.

Further, the protrusions may be provided on the contact portion with which the strap 401 comes into contact in the case main body 5. More specifically, the protrusions may be provided on the lower surface 19 of the case main body 5 (See FIG. 2), on the spring bar 23 of the first bow 7 (See FIG. 4), and on the connection portion 33 of the second bow 9 (See FIG. 4).

### Third Embodiment

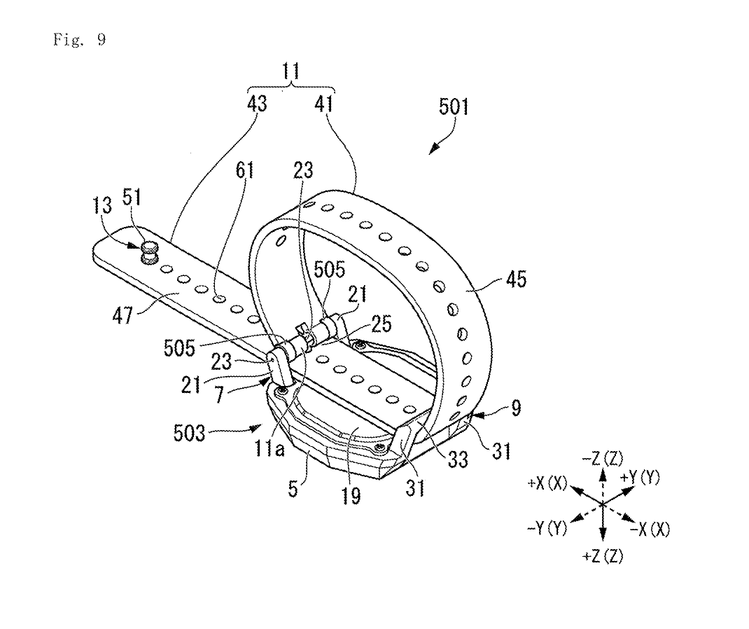

A timepiece 501 according to the third embodiment of the present invention will be described with reference to FIG. 9. The components that are the same as those of the above-described embodiments are indicated by the same reference numerals, and a description thereof will be left out.

FIG. 9 is a perspective view, as seen from the back side, of the timepiece 501 of the third embodiment. The timepiece 501 is equipped with a timepiece case 503, and a movement. The timepiece case 503 is equipped with the case main body 5, the first bow 7, the second bow 9, the strap 11, and the fixation member 13.

In the timepiece case 503, rotation members 505 are cylindrical members having, for example, insertion holes. The spring bar 23 is inserted into the insertion holes. The rotation members 505 are respectively arranged at both end portions in the length direction (the Y-direction) of the spring bar 23.

The outer diameter of the rotation members 505 is larger than the outer diameter of the one end portion 11a of the strap 11. As described above, the one end portion 11a is rotatable around the axis of the spring bar 23, so that the rotation members 505 are relatively rotatable around the axis of the spring bar 23 with respect to the one end portion 11a. The rotation members 505 may be rotatable around the axis with respect to the spring bar 23, or may be fixed to the spring bar 23. The sum total of the length (the dimension in the Y-direction) of the rotation members 505 is shorter than the entire width (the dimension in the Y-direction) of the one end portion 11a of the belt 11.

When it is inserted into the first passage hole 25 for fastening and moves in the length direction, the strap 11 (the portion including the other end portion 11b) abuts the rotation members 505, but it does not easily abut the one end portion 11a of the strap 11 of a small outer diameter. Thus, it is possible to suppress the contact area with which the strap 11 comes into contact with the other members. Thus, it is possible to reduce the friction at the time of the fastening of the strap 11.

In the case where the rotation members 505 are rotatable with respect to the spring bar 23, the rotation members 505 also rotate as the strap 11 moves at the time of the fastening of the strap 11. Thus, it is possible to further reduce the friction at the time of the fastening of the strap 11.

The effects of the timepiece case 503 will be described.

(1) The timepiece case 503 is equipped with the rotation members 505, so that it is possible to reduce the friction at the time of the fastening of the strap 11. Thus, it is possible to easily fasten the strap 11. Thus, the timepiece 503 allows easy attachment.

(2) In the timepiece case 503, in the case where the rotation members 505 are rotatable, it is possible to reduce the friction of the strap 11 by utilizing the rotation of the rotation members 505. Thus, the strap 11 can be easily fastened.

While in the timepiece case 503 the rotation members 505 are provided on the spring bar 23 (contact portion), it is only necessary for the construction of the slip portion to be one capable of reducing the friction between the strap 11 and the contact portion, and it is not restricted to the example shown. For example, while in the timepiece case 503 two rotation members 505 are used, there are no particular restrictions regarding the number of rotation members. It may be an arbitrary number of one or more. The rotation members are not restricted to be the cylindrical configuration. They may be of spherical configuration. Further, the slip portions may not be rotatable so long as they are of a structure capable of reducing the friction between themselves and the strap 11. The rotation members may be mounted to the strap, for example, so as to be rotatable around the spring bar.

While in the timepiece cases of the second embodiment and of the third embodiment the protrusions 403 and the rotation members 505 are respectively used as the slip portions, both the protrusions 403 and the rotation members 505 may be used. Further, apart from the protrusions and the rotation members, the slip portions may, for example, be a sheet of high slipping property.

The specific construction is not restricted to that of the embodiments described in detail above, and a change in design not departing from the scope of the gist of the present invention is included in the present invention.

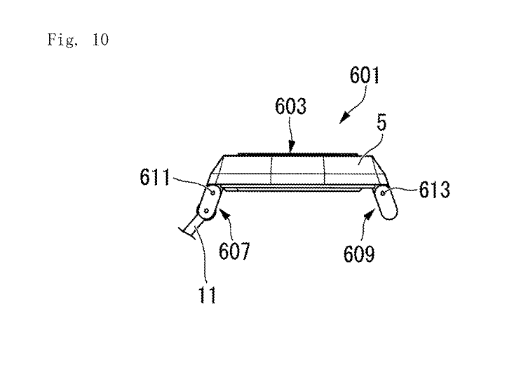

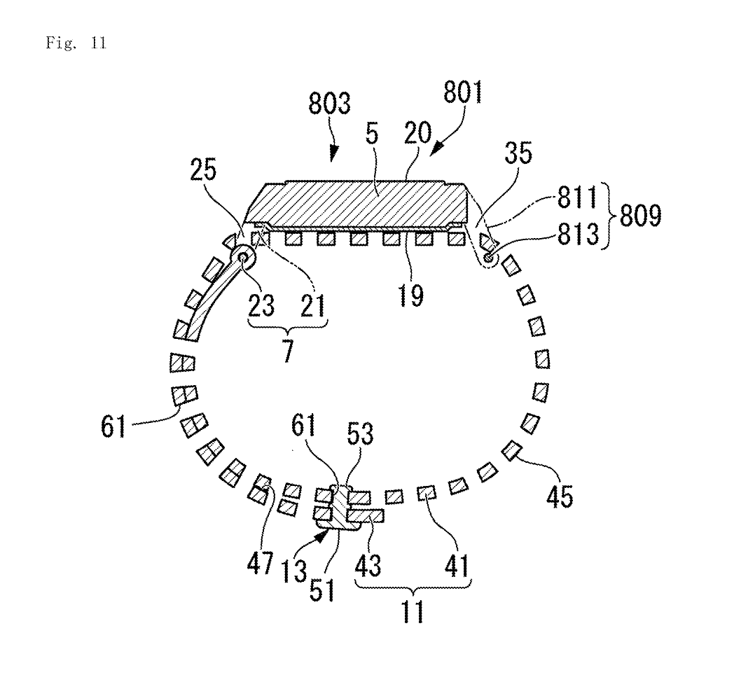

For example, as in the case of a timepiece case 603 shown in FIG. 10, a first bow 607 and a second bow 609 may be provided on the case main body 5 so as to be rotatable respectively around rotation shafts 611 and 613. Further, one of the first bow 607 and the second bow 609 may be rotatably provided on the case main body 5. In this structure, it is possible to enhance the attachment property of the timepiece case 603. In FIG. 10, numeral 601 indicates a timepiece employing the timepiece case 603.

The fixation member for fixing the extension portion to the main portion may be at least one of a free ring and a magnet. The magnet is a permanent magnet or the like, and fixes the extension portion to the main portion by a magnetic force. For example, it is possible to show a construction in which a magnet is provided on one of the extension portion and the main portion and in which at least a part of the other consists of a magnetic metal. Further, it is possible to use a plurality of fixation members.

While in the timepiece case 3 (and the timepiece 1) of the embodiment shown in FIGS. 1 and 2, the second bow 9 is composed of the second bow legs 31 and the connection portion 33, the timepiece case (and the timepiece) of the embodiment may adopt the construction as shown in FIG. 11. In a timepiece case 803 (and a timepiece 801) shown in FIG. 11, a second bow 809 is composed of second bow legs 811 and a spring bar 813. In the timepiece case 803, it is possible to obtain a fixation structure of high strength independently of the material of the case main body 5. In FIG. 11, the fixation member is omitted.

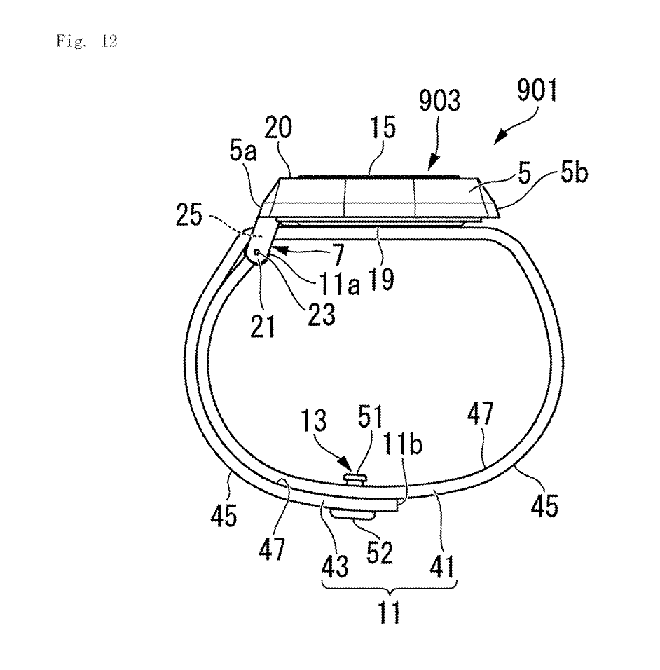

While the timepiece case 3 (and the timepiece 1) of the embodiment shown in FIGS. 1 and 2 is equipped with the first bow 7 and the second bow 9, the timepiece case (and the timepiece) may adopt the construction as shown in FIG. 12. A timepiece case 903 (and a timepiece 901) as shown in FIG. 12 differs from the timepiece case 3 (and the timepiece 1) shown in FIGS. 1 and 2 in that it is equipped with no second bow.

While in the above-described embodiments the present invention is applied to a timepiece case, the present invention is applicable to any other portable apparatus case equipped with a strap. While in the above-described embodiments the present invention is applied to a portable apparatus case attached to the arm, the object of attachment is not restricted to the arm. For example, the present invention may be applied to a portable apparatus case attached to a body portion other than the arm.

The portable apparatus component is not restricted to a timepiece movement. For example, it may be a component of an apparatus such as an activity tracker, a heart rate meter, a pedometer, an altimeter, or a barometer.

What is claimed is:

1. A portable apparatus case comprising:
a case main body,
a strap mounting portion having a passage hole and provided on the case main body,
a strap one end portion of which is mounted to the strap mounting portion and the other end portion of which is passed through the passage hole, and
a fixation member provided on an extension portion of the strap extending from the passage hole to the outside and detachably connected to a main portion extending from the strap mounting portion to the passage hole.

2. The portable apparatus case according to claim 1, wherein the strap mounting portion is provided at one end portion of the case main body; and
a support portion supporting the main portion is provided at the other end portion of the case main body.

3. The portable apparatus case according to claim 1, wherein the fixation member is a lock portion detachably locked to a locked portion formed on the main portion.

4. The portable apparatus case according to claim 1, further comprising a slip portion provided on at least one of the strap and a contact portion brought into contact with the strap, and configured to reduce the friction between the strap and the contact portion.

5. The portable apparatus case according to claim 4, wherein the slip portion is a protrusion at least the distal end portion of which is formed in a curved convex configuration.

6. The portable apparatus case according to claim 4, wherein the slip portion is a rotation member provided on at least one of the strap and the contact portion, and is rotatable around an axis crossing the length direction of the strap.

7. A portable apparatus comprising:
the portable apparatus case as claimed in claim 1, and
a portable apparatus component accommodated in the portable apparatus case.

8. A timepiece comprising:
the portable apparatus case as claimed in claim 1, and
a movement accommodated in the portable apparatus case.
